(19) United States
(12) Patent Application Publication
(10) Pub. No.: US 2017/0161011 A1
(43) Pub. Date: Jun. 8, 2017

(54) Play control method and electronic client

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Zhongjie ZHANG, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/242,096

(22) Filed: Aug. 19, 2016

Related U.S. Application Data
(63) Continuation of application No. PCT/CN2016/089526, filed on Jul. 10, 2016.

(30) Foreign Application Priority Data
Dec. 3, 2015 (CN) 2015108827040

(51) Int. Cl. G06F 3/16; G06F 3/0346

(52) U.S. Cl. CPC G06F 3/165; G06F 3/0346; H04M 1/72569

(57) ABSTRACT

A play control method and electronic device are provided, which can implement controlling play of a media stream by non-touch methods, for example, deflecting a mobile phone, shaking or the like, wherein the method includes: acquiring a motion state signal of a client; and controlling play of a media stream in the client according to the motion state signal.

### CROSS-REFERENCE TO RELATED APPLICATIONS

The application is a continuation of PCT application No. PCT/CN2016/089526 submitted on Jul. 10, 2016. The present application claims priority to Chinese Patent Application No. 201510882704.0, filed with the Chinese Patent Office on Dec. 3, 2015, both of which are incorporated herein by reference in their entireties.

### TECHNICAL FIELD

The present disclosure relates to the field of media stream play technologies, and in particular, to a play control method and an electronic client.

### BACKGROUND

A media stream play APP (Application) refers to a third-party APP capable of playing a media stream stored in the form of a digital signal. A user implements various operations, for example, fast forward or rewind, or playing a next media stream, etc., by controlling the APP.

In prior art, if a user wants to control fast forward or rewind of one media stream in a media stream play APP, the user needs to touch a corresponding key or shortcut key on a display screen, so as to enable the APP to perform a corresponding operation. However, in actual use, when a user wants to fast forward one media stream in the APP, the user possibly cannot touch a corresponding progress bar on a display screen; for example, when a user takes a public vehicle and has to hold things and an armrest at the same time, it is inconvenient to touch a progress bar by using a finger.

### SUMMARY

An embodiment of the present disclosure provides a play control method, where the method includes: acquiring a motion state signal of a client; and controlling play of a media stream in the client according to the motion state signal.

An embodiment of the disclosure further provides a non-transitory computer-readable storage medium, which stores executable instructions, where the executable instructions is used to execute any of the foregoing play control method of the present disclosure.

An embodiment of the present disclosure further provides an electronic device, including: at least one processor; and a memory in communication connection with the at least one processor. The memory stores instructions that can be executed by the at least one processor, and the instructions are executed by the at least one processor, so that the at least one processor can execute any of the foregoing play control method of the present disclosure. t.

By using the play control method and electronic device provided in the embodiments of the present disclosure, by collecting a motion state signal of a client, and subsequently controlling play of a media stream in the client according to the motion state signal, play of a media stream can be controlled by means of non-touch methods, such as deflecting a mobile phone, shaking or the like.

### BRIEF DESCRIPTION OF THE DRAWINGS

One or more embodiments are exemplarily described by figures corresponding thereto in the accompanying drawings, and the exemplary descriptions do not constitute a limitation on the embodiments. Elements with the same reference numbers in the accompanying drawings represent similar elements. Unless otherwise particularly stated, the figures in the accompanying drawings do not constitute a scale limitation. In the accompanying drawings:

FIG. 1 is a schematic structural diagram of an exemplary play control device of an implementation manner of the present disclosure; and

FIG. 2 is a flowchart of an exemplary play control method of an implementation manner of the present disclosure;

FIG. 3 is a schematic structural diagram of hardware of an electronic device for executing a play control method provided in an implementation manner of the present disclosure.

### DESCRIPTION OF REFERENCE NUMBERS

100 Acquiring module 200 Control module

### DETAILED DESCRIPTION

The following describes specific implementation manners of the present disclosure in detail with reference to the accompanying drawings. It should be understood that the specific implementation manners described herein are merely used for describing and explaining the present disclosure, and are not used to limit the present disclosure.

To describe the concept of the present disclosure in detail and clearly, a play control device, electronic device and method provided in the present disclosure are described below in detail by using a client provided in an embodiment of the present disclosure as an example. However, the embodiments of the present disclosure are not used to limit the following implementation manners. The client may be a device, for example, a mobile phone, a computer, or a tablet computer, etc. The client may be configured with a motion state detection device configured to detect a motion state of the client and generate a motion state signal provided in the present disclosure; and the play control device when the client leaves a factory or according to a user's need during use.

Specifically, the motion state detection device may include at least one of a gyroscope and an accelerator sensor (a function and a principle of the motion state detection device are the same as those in prior art, which will not be described herein again to avoid obscuring a protection scope of the present disclosure). These motion state detection devices can separately detect and reflect a parameter of a motion state of the client, and correspondingly generate a motion state signal. For example, the motion state signal may be an angle signal from the gyroscope, or an acceleration signal from the accelerator sensor. Subsequently, the play control device provided in the embodiment of the present disclosure can control play of a media stream according to acquired different motion state signals. For example, the media stream may include a video and an audio; in particular, the play control device, electronic device and method provided in an embodiment of the present disclosure can be used to control play of a video and control play of an audio.

FIG. 1 is a schematic structural diagram of an exemplary play control device according to an implementation manner of the present disclosure. As shown in FIG. 1, the play control device may include: an acquiring module 100 and a control module 200. The acquiring module 100 acquires a motion state signal of a client, that is, acquires a motion state signal from the foregoing motion state detection device; and the control module 200 controls play of a media stream in the client according to the motion state signal, and specifically, to control play of a video or an audio. By means of such an implementation manner, a user can control play of a media stream in a client by changing a motion state of the client, for example, controlling fast forward or rewind of a video or an audio being played, or playing a next video or audio, so as to implement non-touch control by the user on video or audio play, thereby improving user experience and being more humanized.

Because the client includes multiple kinds of motion state detection devices (for example, an acceleration sensor, a gyroscope or the like), in the following, the present disclosure will provides multiple implementation manners to implement control on play of a media stream.

### Embodiment 1

In embodiment 1, the motion state signal is an angle signal from a gyroscope, and the control module 200 can control play of a media stream in the client according to the motion state signal, where includes: the control module 200 can control fast forward or rewind of the media stream according to an inclination angle from the gyroscope; for example, the control module 200 can pre-store different media stream fast forward or rewind times corresponding to different inclination angles, or a user can set according to an actual situation. For example, on a setting page of a video APP, the user can customize correspondences between different inclination angles and fast forward or rewind times of a video (for example, fast forward for 1 minute corresponds to a left inclination of 45 degrees, or rewind for 1 minute corresponds to a right inclination of 45 degrees), or set a default value of system. After the setting, the control module 200 can control fast forward or rewind of the video according to the inclination angles. Alternatively, for example, on a setting page of an audio APP, the user can customize correspondences between different inclination angles and fast forward or rewind times of an audio (for example, fast forward for 1 minute corresponds to a left inclination of 45 degrees, or rewind for 1 minute corresponds to a right inclination of 45 degrees), or set a default value of system. After the setting, the control module 200 can control fast forward or rewind of the audio according to the inclination angles.

For example, when a user needs to fast forward a video or an audio being played (for example, when the user takes a public vehicle and has to hold things and an armrest at the same time, it is difficult to touch a fast forward key of a mobile phone by using a finger to fast forward the video or audio being played), the user may incline the client (for example, a mobile phone) for an angle (for example, a left inclination of 45 degrees); the gyroscope in the mobile phone can sense the angle and generate an angle signal; the control module 200 in the mobile phone can acquire a value of the angle signal and acquire the foregoing set fast forward time of an audio/video corresponding to the angle; and subsequently, the control module 200 can fast forward the video or audio according to the fast forward time (for example, fast forward for 1 minute the video/audio), so as to control video/audio play in a non-touch manner.

### Embodiment 2

In embodiment 2, the motion state signal is an acceleration signal from an acceleration sensor, and the control module 200 can control play of a media stream in the client according to the motion state signal, where includes: the control module can control to play a next media stream according to a value of the acceleration signal and an acceleration threshold, where the control module 200 can pre-store an acceleration threshold, which can be set according to an actual situation. For example, on a setting page of a video APP, a user can enter an expected value which is not limited by the present disclosure. The control module 200 can control to play a next video in a case in which the value of the acceleration signal of the acceleration sensor is greater than the acceleration threshold. For example, a video next to a current video in a video play list is played. Alternatively, for example, on a setting page of an audio APP, a user can enter an expected value which is not limited by the present disclosure. The control module 200 can control to play a next audio in a case in which the value of the acceleration signal of the acceleration sensor is greater than the acceleration threshold. For example, an audio next to a current audio in an audio play list is played.

For example, when a user needs to pause a video or an audio being played (for example, when the user takes a public vehicle and has to hold things and an armrest at the same time, it is difficult to touch a key of a mobile phone by using a finger to select a video next to a video being played or an audio next to an audio being played), the user may (for example, at a certain rate) shake the client (for example, a mobile phone); the acceleration sensor in the mobile phone can sense the acceleration and generate an acceleration signal; the control module 200 in the mobile phone can acquire a value of the acceleration signal and compare it with a set acceleration threshold; if the value of the acceleration signal is greater than the acceleration threshold, the control module 200 can control to play a next video/audio. For some interference signals (for example, when the user is walking), because a value of a generated acceleration signal is less than the set acceleration threshold, control on video/audio play is generally not affected.

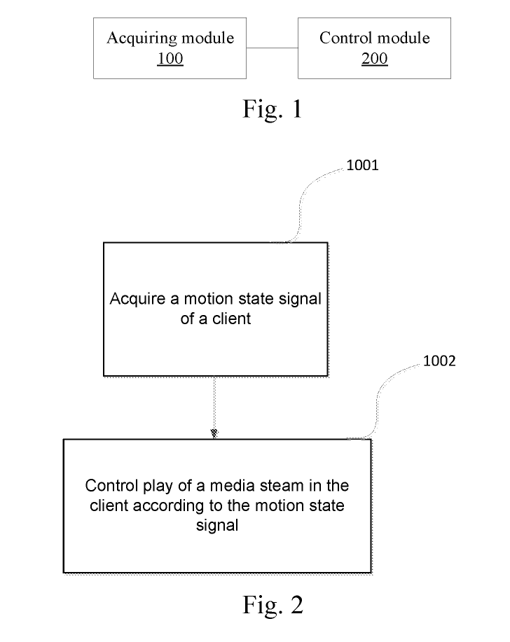

FIG. 2 shows an exemplary flowchart of a play control method. As shown in FIG. 2, the method may include the following steps:

step 1001: acquiring a motion state signal of a client ; and

step 1002: controlling play of a media stream in the client according to the motion state signal.

Optionally, the motion state signal is an angle signal from a gyroscope; and the controlling play of a media stream in the client according to the motion state signal includes: controlling fast forward or rewind of the media stream according to an inclination angle from the gyroscope.

Optionally, the controlling fast forward or rewind of the media stream according to an inclination angle from the gyroscope includes: controlling different fast forward or rewind times of the media stream according to different inclination angles from the gyroscope.

Optionally, the motion state signal is an acceleration signal from an acceleration sensor; and the controlling play of a media stream in the client according to the motion state signal includes: controlling to play a next media stream according to a value of the acceleration signal and an acceleration threshold.

Optionally, the controlling to play a next media stream according to a value of the acceleration signal and an acceleration threshold includes: playing a next media stream in a case in which the value of the acceleration signal is greater than the acceleration threshold.

By using the play control method provided in the embodiments of the present disclosure, play of a media stream, for example, fast forward or rewind, or playing a next media stream, etc., can be controlled by means of non-touch methods, for example, deflecting a mobile phone, shaking or the like, so as to control play of a media stream conveniently and quickly.

An implementation manner of the disclosure further provides a non-transitory computer-readable storage medium, which stores a computer-readable executable instruction, where the computer-readable executable instruction can execute the play control method in any of the foregoing method embodiments.

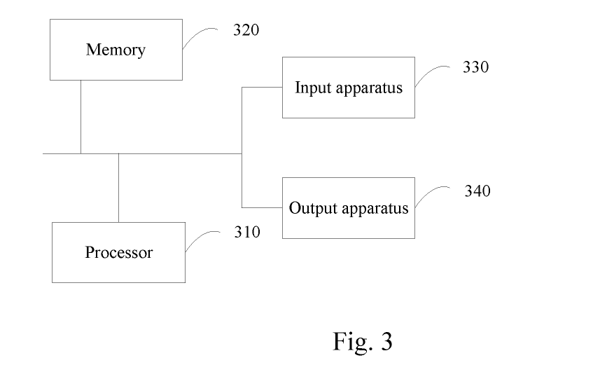

FIG. 3 is a schematic structural diagram of hardware of an electronic device for executing a play control method provided in an implementation manner of the disclosure. As shown in FIG. 3, the device includes:

one or more processors 310 and a memory 320, with one processor 310 as an example in FIG. 3.

A device for executing the play control method may further include: an input apparatus 330 and an output apparatus 340.

The processor 310, the memory 320, the input apparatus 330, and the output apparatus 340 can be connected by means of a bus or in other manners, with a connection by means of a bus as an example in FIG. 3.

As a non-transitory computer-readable readable storage medium, the memory 320 can be used to store non-transitory software programs, non-transitory computer-readable executable programs and modules, for example, a program instruction/module corresponding to the play control method in the embodiments of the disclosure (for example, the acquiring module 100 and the control module 200 shown in FIG. 1). The processor 310 executes various functional applications and data processing of the server, that is, implements the play control method of the foregoing method embodiments, by running the non-transitory software programs, instructions, and modules stored in the memory 320.

The memory 320 may include a program storage area and a data storage area, where the program storage area may store an operating system and at least one application needed by function; the data storage area may store data created according to use of the play control device, and the like. In addition, the memory 320 may include a high-speed random access memory, and also may include a non-transitory memory such as at least one disk storage device, flash storage device, or other non-transitory solid-state storage devices. In some embodiments, the memory 320 optionally includes memories remotely disposed with respect to the processor 310, and the remote memories may be connected, via a network, to the play control device. Examples of the foregoing network include but are not limited to: the Internet, an intranet, a local area network, a mobile communications network, and a combination thereof

The input apparatus 330 can receive entered digit or character information, and generate key signal inputs relevant to user setting and functional control of the play control device. The output apparatus 340 may include a display device, for example, a display screen, etc.

The one or more modules are stored in the memory 320, and execute the play control method in any of the foregoing method embodiments when being executed by the one or more processors 310.

The foregoing product can execute the method provided in the embodiments of the disclosure, and has corresponding functional modules for executing the method and beneficial effects. The method provided in the embodiments of the disclosure can be referred to for technical details that are not described in detail in the embodiment.

The electronic device in the embodiment of the disclosure exists in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer, but higher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer-readable storage medium, for example, a ROM/RAM, a magnetic disk, a compact disc or the like, including several instructions for enabling a computer device (which may be a personal computer, a sever, or a network device, and the like) to execute the method described in the embodiments or in some parts of the embodiments.

Finally, it should be noted that the foregoing embodiments are only for the purpose of describing the technical solutions of the disclosure, rather than limiting thereon. Although the disclosure has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the disclosure.

1. A play control method applied in an electronic device, comprising:
acquiring a motion state signal of a client; and
controlling play of a media stream in the client according to the motion state signal.

2. The method according to claim 1, wherein the motion state signal is an angle signal from a gyroscope; and the controlling play of a media stream in the client according to the motion state signal comprises: controlling fast forward or rewind of the media stream according to an inclination angle from the gyroscope.

3. The method according to claim 2, wherein the controlling fast forward or rewind of the media stream according to an inclination angle from the gyroscope comprises:
controlling different fast forward or rewind times of the media stream according to different inclination angles from the gyroscope.

4. The method according to claim 1, wherein the motion state signal is an acceleration signal from an acceleration sensor; and the controlling play of a media stream in the client according to the motion state signal comprises:
controlling to play a next media stream according to a value of the acceleration signal and an acceleration threshold.

5. The method according to claim 4, wherein the controlling to play a next media stream according to a value of the acceleration signal and an acceleration threshold comprises:
playing a next media stream in a case in which the value of the acceleration signal is greater than the acceleration threshold.

6.-13. (canceled)

14. A non-transitory computer-readable storage medium, which stores executable instructions that, when executed by an electronic device, cause the electronic device to:
acquire a motion state signal of a client; and
control play of a media stream in the client according to the motion state signal.

15. The non-transitory computer-readable storage medium according to claim 14, wherein the motion state signal is an angle signal from a gyroscope; and the instruction to control play of a media stream in the client according to the motion state signal causes the electronic device to: control fast forward or rewind of the media stream according to an inclination angle from the gyroscope.

16. The non-transitory computer-readable storage medium according to claim 15, wherein the instruction to control fast forward or rewind of the media stream according to an inclination angle from the gyroscope cause the electronic device to:
control different fast forward or rewind times of the media stream according to different inclination angles from the gyroscope.

17. The non-transitory computer-readable storage medium according to claim 14, wherein the motion state signal is an acceleration signal from an acceleration sensor; and the instruction to control play of a media stream in the client according to the motion state signal cause the electronic device to:
control to play a next media stream according to a value of the acceleration signal and an acceleration threshold.

18. The non-transitory computer-readable storage medium according to claim 17, wherein the instruction to control to play a next media stream according to a value of the acceleration signal and an acceleration threshold cause the electronic device to:
play a next media stream in a case in which the value of the acceleration signal is greater than the acceleration threshold.

19. An electronic device, comprising:
at least one processor; and
a memory in communication connection with the at least one processor; wherein the memory stores instructions executable by the at least one processor, wherein execution of the instructions by the at least one processor, causes the at least one processor to:
acquire a motion state signal of a client; and
control play of a media stream in the client according to the motion state signal.

20. The electronic device according to claim 19, wherein the motion state signal is an angle signal from a gyroscope; then, the execution of the instructions to control play of a media stream in the client according to the motion state signal causes the at least one processor to:
control fast forward or rewind of the media stream according to an inclination angle from the gyroscope.

21. The electronic device according to claim 20, wherein the execution of the instructions to control fast forward or rewind of the media stream according to an inclination angle from the gyroscope causes the at least one processor to:
control different fast forward or rewind times of the media stream according to different inclination angles from the gyroscope.

22. The electronic device according to claim 19, wherein the motion state signal is an acceleration signal from an acceleration sensor; then, the execution of the instructions to control play of a media stream in the client according to the motion state signal causes the at least one processor to:
control to play a next media stream according to a value of the acceleration signal and an acceleration threshold.

23. The electronic device according to claim 22, wherein the execution of the instructions to control to play a next media stream according to a value of the acceleration signal and an acceleration threshold causes the at least one processor to:
play a next media stream in a case in which the value of the acceleration signal is greater than the acceleration threshold.
